(19) United States
(12) Patent Application Publication
(10) Pub. No.: US 2026/0257558 A1
(43) Pub. Date: Sep. 3, 2026

(54) User Interface, Means of Transportation, and Method for Displaying a Traffic Situation

(71) Applicant: Volkswagen Aktiengesellschaft, Wolfsburg (DE)

(72) Inventors: Robert Jan Wyszka, Hannover (DE); Eduardo Luiz Vieira, Berlin (DE); Adrian Wendt, Braunschweig (DE)

(73) Assignee: Volkswagen Aktiengesellschaft, Wolfsburg (DE)

(21) Appl. No.: 19/163,951

(22) PCT Filed: Feb. 15, 2024
(86) PCT No.: PCT/EP2024/053828

§ 371 Date: Sep. 10, 2025

(30) Foreign Application Priority Data
Mar. 14, 2023 (DE) 10 2023 202 304.0

(51) Int. Cl. B60K 35/28; B60K 35/22; B60K 35/81; G01C 21/36

(52) U.S. Cl. CPC B60K 35/28; B60K 35/22; B60K 35/81; G01C 21/3694; B60K 2360/166

(57) ABSTRACT

The disclosure relates to a user interface, a means of transportation, and a method for displaying a representation of a traffic situation in a first display are of a graphical user interface of a means of transportation. The method comprises the steps of: determining a speed of the means of transportation and adjusting a vanishing point of the representation of the traffic situation of a first display area depending on the speed.

### CROSS-REFERENCE TO RELATED APPLICATIONS

This application claims priority to German Patent Application DE 10 2023 202 304.0, filed Mar. 14, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a user interface, a means of transportation, and a method for displaying a traffic situation in a first display area of a graphical user interface. In particular, the disclosure relates to a dynamic and, in particular, efficient use of an available graphical user interface.

Means of transportation with increasingly larger display surfaces are being provided in the prior art. In particular, it is known to depict driving situations (driver assistance functions and driver assistance scenarios) and road map material. In addition, widgets are known which split subregions of display interfaces into separate logical units and can be associated with respective functional scopes. The widgets are typically rectangular in shape or else are provided with predefined horizontal and/or vertical delimitation lines.

### SUMMARY

A need exists to use an available display surface efficiently. The need is addressed by the subject matter of the independent claim(s). Embodiments of the invention are described in the dependent claims, the following description, and the drawings.

### BRIEF DESCRIPTION OF THE DRAWINGS

FIG. 1 shows a schematic depiction of an embodiment of a means of transportation;

FIGS. 2 to 4 show depictions of an example user interface configured according to the teachings herein, depending on a travel speed of the means of transportation; and

FIG. 5 shows steps of an embodiment of a method according to the teachings herein.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, the method serves to display a traffic situation in a first display area of a graphical user interface of a means of transportation. The user interface can be understood to be a freely programmable design of one or more matrix displays. The traffic situation may include, in particular, a depiction in which a representation of the ego means of transportation and/or a view of the road through the front window of the ego means of transportation is depicted. In other words, a perspective of the road view of the ego means of transportation oriented in the direction of travel is produced. The first display area can be understood to be an interface area of the graphical user interface that is distinct from a second display area in terms of software or else programming. In a first step, a speed of the means of transportation is determined using sensors. Here, the sensors of the ego means of transportation can be used. Alternatively or additionally, additional, in particular mobile, portable user terminals can be used for determining the speed of the means of transportation. A vanishing point or else vanishing point position of the representation of the traffic situation in the first display area is then adjusted depending on the speed. Since events in close proximity to the ego means of transportation are generally more important than far-off events at low speeds, for example, and since the far-off events have increased importance at increasing speed, the representation of the traffic situation can be designed in such a way by adjusting the position of the vanishing point that the perspective changes from a more downward-looking perspective to a more forward-looking perspective when the speed of the means of transportation increases. In other words, a bird's-eye view or similar perspective changes to a perspective directed ahead of the area of the ego means of transportation when the speed increases. In the process, the vanishing point moves from a position a short distance in front of the ego means of transportation to a position that is multiple hundreds of meters ahead in the distance or else on the horizon (infinite). In this way, the objects located in the environment of the means of transportation can be depicted larger at lower speeds and more objects from the surroundings lying ahead can be depicted at higher speeds. The ego means of transportation may be depicted in the representation of the traffic situation or located behind the position of the viewer (view out of the windscreen of the means of transportation).

The first display area may have a first boundary line with respect to an immediately adjacent second display area that stretches out towards the vanishing point. In other words, a second display area may be assigned to another or a related topic within the same display and thus a sort of “split-screen depiction” can be achieved. In contrast to conventional display apparatuses, however, the split screen is not segmented horizontally and/or vertically or rather statically, but rather in particular dynamically, depending on the current position of the vanishing point along a line that extends into the vanishing point. Said first boundary line may, for example, extend towards the vanishing point following a roadway boundary that is located to the right of the ego means of transportation or else a crash barrier located to the right with respect to the ego means of transportation in the case of right-lane traffic. The second display area located beyond the first boundary line can therefore fill the screen surface in a complementary manner. For example, the second display area may comprise a plan view of a depiction of a map and/or another type of depiction. This does not exclude further (superimposed) notices or else information fields positioned both partially in the first image area and partially in the second image area from potentially overlapping the first boundary line. For example, by using blur filters, a superior depiction of a pop-up or notice field can be generated without the first boundary line being completely covered beneath the notice. The boundary line can thus be discerned dynamically and intuitively and the screen surface beyond the representation of the road being traveled on can be optimally utilized for other purposes.

The first boundary line may, for example, start at a stationary position on a lower edge of the first display area and be oriented towards the (position-variable) vanishing point. Alternatively, the first boundary line may also be located in a variable manner on the lower edge of the display area. In particular, the location of the upper region of the first boundary line (i.e., the section closest to the vanishing point) may be positioned in a variable manner in order to constantly be aligned with the vanishing point. The same applies, of course, to a boundary line opposite the first boundary line with respect to the first display area, said opposing boundary line demarcating, for example, the first image area from an immediately adjacent fourth image area. In particular, the first image area may be designed symmetrically in order to facilitate orientation by the user. In other words, the first boundary line and the third boundary line then behave symmetrically with respect to an axis that extends from the center of the image or else ego perspective and towards the vanishing point.

The second image area may comprise a plan view of a digital road map that also comprises the ego position of the ego means of transportation, for example. The digital map may then be moved such that the ego position is located in each case in a predefined area within the second display area. Alternatively or additionally, further information may also be depicted in the second image area in order to make the display visually attractive and/or informative. In particular, the user can configure the information within the second display area and/or first display area in a configuration menu. The same applies to any notices/pop-ups that are (partially) superimposed on the first and second display area.

As soon as the currently traveled speed of the means of transportation changes, this can be established by means of sensors. In response hereto, a vertical position (Z position) of the vanishing point, for example, can be varied depending on the changed speed. The vanishing point may be located within the depiction or above/below the display or rather first display area. In particular, the vanishing point may be located outside the first display area at higher speeds, but within the first display area at low speeds (e.g. less than 50 km/h).

If multiple display units (displays, in particular implemented in hardware and spatially separated from one another) are used for the graphical user interface, a first display can be provided by the instrument cluster and/or a second display can be provided by a central display apparatus (central display unit). Depending on the vehicle concept, the two displays may also be implemented in separate hardware and/or segmented solely by optical screens or dividers. The first display area may, in particular, be located fully in the instrument cluster, whereas the second display area is only partially located on the instrument cluster and otherwise in the region of the central display unit. This does not exclude a fourth display area from being located to the left of the first display area on the instrument cluster, while a third display area is located to the right of the second display area on the central display unit. The depiction of the second display area thus connects the two displays optically and logically, resulting in a holistic, particularly logical, and intuitively understandable graphical user interface.

If a third display area adjoins the second display area, said third display area can be demarcated from the second display area by a second boundary line. Since the first boundary line changes depending on the vehicle speed, the second boundary line can undergo a corresponding change in order to provide a symmetrical image. Alternatively, the second boundary line can also be arranged in a stationary manner in order to steady the entire depiction. In particular, for example, the second boundary line may have an inclination that corresponds to the third boundary line or else extend in parallel with the third boundary line. This, in turn, steadies the depiction and helps produce a tidy appearance.

Whenever reference is made to a “speed” in the present disclosure, this should also be understood to mean a speed of the means of transportation which is changed at a later point in time, said means of transportation being operated accordingly with the user interface according to the teachings herein.

According to some embodiments, a user interface is proposed for displaying a traffic situation in a first display area of a graphical user interface of a means of transportation. The graphical user interface may, for example, be depicted on an instrument cluster and/or a display at the base of the windscreen and/or a head-up display and/or a central display unit (central information display). The means of transportation may be designed as a passenger car, van, motorcycle, truck, aircraft, and/or watercraft. The explanations regarding the traffic situation or rather the representation of the traffic situation correspond to those that were described in connection with the method according to the teachings herein. The user interface comprises a data input, a data output, and an evaluation apparatus that can process data contained via the data input and can output results of the data processing via the data output. The evaluation unit is thus capable of determining a speed of the means of transportation by means of the data input, wherein said evaluation unit can read out data from a vehicle bus, for example. By means of the data output, the evaluation unit can adjust a vanishing point of the representation of the traffic situation in the first display area depending on the speed. For example, altered image material and/or altered information relating to a position of the vanishing point of the representation of the traffic situation can be output via the data output to a display apparatus (a display or else display assembly). According to the method, the user interface is thus configured to raise or lower the vanishing point depending on the speed. The features, combinations of features, and the resulting benefits correspond to those mentioned above in an obvious manner, and therefore reference should be made to the above explanations in order to avoid repetitions.

According to some embodiments, a means of transportation is proposed which comprises a user interface according to the teachings herein. The means of transportation may be designed as a passenger car, van, motorcycle, truck, aircraft, and/or watercraft. It comprises a user interface of the like provided according to the prior art and is configured in terms of information technology to execute the steps of a method according to the teachings herein and thus to realize the same features, combinations of features, and benefits of the method.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

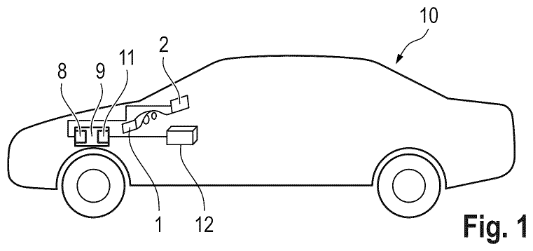

FIG. 1 shows a passenger car as the means of transportation 10, which can also be referred to as the ego means of transportation. The passenger car comprises a central information display 2 and a digital instrument cluster 1. The instrument cluster 1 and the central information display 2 are connected to a data output 8 of an electronic control unit as the evaluation unit 9. The evaluation unit 9 obtains speed signals from a central driving dynamics control system or rather from the control unit 12 thereof via a data input 11. In particular, a current speed signal is provided by the control unit 12.

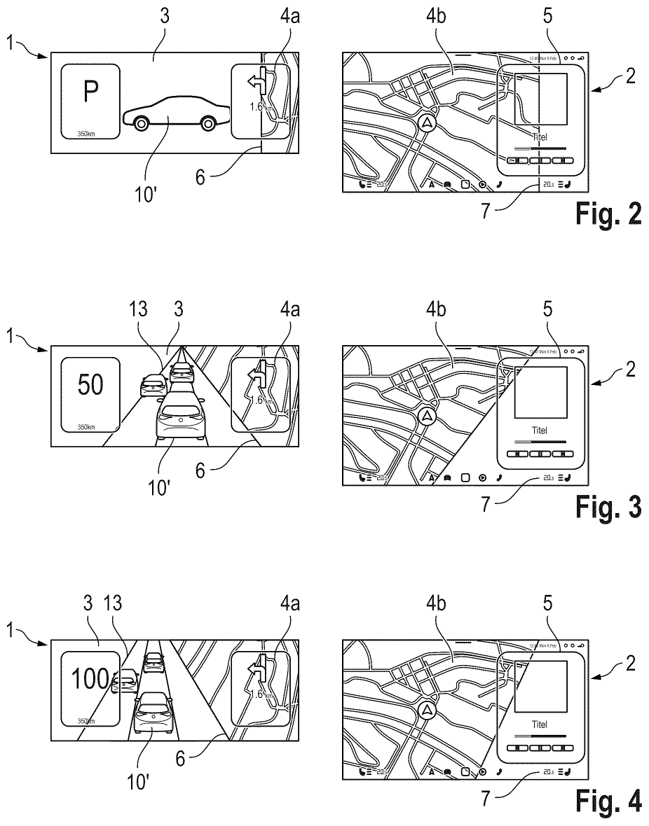

FIG. 2 shows a user interface comprising two screens, of which one on the left-hand side depicts a first graphical user interface 1 and one on the right-hand side depicts a second graphical user interface 2. The first graphical user interface 1 is split into a first display area 3 and a part 4a of a second display area 4a, b. The first display area 3 shows a representation 10′ of the ego means of transportation (see FIG. 1, reference sign 10). In addition, a currently selected gear or else a current driving state, a current range, a next upcoming maneuver, and a distance until the next upcoming maneuver are depicted. To the right of a first boundary line 6, the first part 4a of the second display area 4a, b shows a plan view of a digital road map. A semi-transparent notice that is optically demarcated by means of a blur filter is superimposed on a right-hand region of the first display area 3 and a left-hand region of the part 4a of the second display area as well as parts of the first boundary line 6. A second part 4b of the second display area 4a, b shows the continued depiction of the plan view of the digital map in addition to the ego position of the means of transportation. A second boundary line 7 visually demarcates the second display area 4a, b with respect to a third display area 5. A superimposed semi-transparent tile representing a music playback function is also partially superimposed on the second boundary line 7. In this way, the right-hand small third display area 5 serves as a visual anchor for the music playback function, while the superimposed notice extends into the second display area 4a, b and may thus occupy a larger surface area for the music playback function. Since the means of transportation is currently parked, there is no need to depict a representation of the traffic situation. Therefore, the first boundary line 6 and the second boundary line 7 are arranged vertically and parallel to one another.

FIG. 3 shows the depiction shown in FIG. 2 after the means of transportation has started moving. A current travel speed of 50 km/h ensures that a representation 10′ of the ego means of transportation is depicted in addition to other road users in a perspective from a position above and behind the ego means of transportation. The vanishing point X is located approximately at the height of the upper edge of the graphical user interface 1 or rather first display area 3. As a result, the first boundary line 6 is then depicted inclined towards the top left and intersects the vanishing point X. The anchor position of the first boundary line 6 on the lower edge of the first display area 3 is unchanged with respect to FIG. 2. A third boundary line 13 is mirror-symmetrical to the first boundary line 6 with respect to a main viewing axis in the direction of travel or rather X direction. The same applies to a second boundary line 7 that separates the second part 4b from the third display area 5 and that extends parallel to the third boundary line 13. Due to the fact that the depiction of the digital map on the second display area 4a, b could be extended to the left, the third display area 5 can be depicted larger to the right in the image and thus the legibility of the music playback information can be improved.

FIG. 4 shows the view depicted in FIG. 3 after the travel speed of the means of transportation has been increased again to 100 km/h. The vanishing point X was raised further and is now located outside the first display area 3. The first boundary line 6 is now no longer inclined as steeply as in FIG. 3 with respect to the vertical. The same applies to the third boundary line 13 and the second boundary line 7. In this exemplary embodiment, it can be seen that the second boundary line 7 is stationarily anchored at the upper edge of the graphical user interface 2, such that the inclination is produced by shifting the position at which said second boundary line intersects with the lower edge of the graphical user interface 2. In the depiction shown, a shift of the vanishing point X is produced by increasing the speed from 50 km/h to 100 km/h, inter alia by raising the viewer position (viewer position at 100 km/h is higher and further behind the ego means of transportation than at 50 km/h).

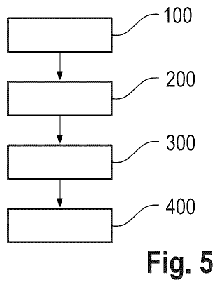

FIG. 5 shows a flow diagram illustrating steps of an exemplary embodiment of a method for displaying a traffic situation in a first display area of a graphical user interface of a means of transportation. In step 100, a speed of the means of transportation is determined by means of sensors and/or read out by a bus system of the means of transportation. Alternatively or additionally, the determination of the speed may include reading out data from a smart device/smart wearable carried by the user. In step 200, a vanishing point of the representation of the traffic situation of a first display area is adjusted depending on the determined speed by raising the position in the Z direction. In this way, a boundary line between the first display area and a second display area immediately adjacent thereto is shifted, since the boundary line extends through the vanishing point and is anchored fixedly at the lower edge of the screen. In step 300, a changed speed of the means of transportation is then determined. This may also take place using sensor technology found in the means of transportation. In response hereto, in step 400, the vertical position of the vanishing point is adjusted again depending on the changed speed. Again, the boundary line between the first display area and a second display area immediately adjacent thereto is continuously adjusted with the speed, thus prompting a continuous change in a layout of the split-screen depiction.

### LIST OF REFERENCE NUMERALS

1, 2 Graphical user interface
3 First display area
4a, b Second display area
5 Third display area
6 First boundary line
7 Second boundary line
8 Data output
9 Evaluation unit
10 Means of transportation
10′ Representation of the means of transportation
11 Data input
12 Control unit
100 to 400 Method steps

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for displaying a representation of a traffic situation in a first display area (3) of a graphical user interface (1, 2) of a means of transportation (10), comprising the steps of:
determining (100) a speed of the means of transportation (10) and
adjusting (200) a vanishing point (x) of the representation of the traffic situation of a first display area (3) depending on the speed.

2. The method according to claim 1, wherein the first display area (3) has a first boundary line (6) with respect to an immediately adjacent second display area (4a, 4b) that stretches out towards the vanishing point (x).

3. The method according to claim 1 or 2, wherein the first boundary line (6) is located in a fixed or variable manner at a position on a lower edge of the display area (3) and in a variable manner on an upper edge of the display area (3).

4. The method according to claim 3, wherein the second display area (4a, 4b) shows a plan view of a digital map.

5. The method according to claim 3 or 4, wherein the first display area (3) represents a straight-ahead view of a road on which the means of transportation (10) is traveling and/or
the first boundary line (6) coincides with a right-hand edge of a representation of a road on which the means of transportation (10) is currently traveling.

6. The method according to any one of the preceding claims, further comprising:
determining (300) a changed speed of the means of transportation (10) and, in response hereto,
adjusting (400) the vanishing point (x) depending on the changed speed.

7. The method according to any one of the preceding claims, wherein the vanishing point (x) is shifted upwards at a higher speed and downwards at a lower speed.

8. The method according to any one of the preceding claims, wherein the graphical user interface (1, 2) is displayed on
an instrument cluster and/or
a central display unit,
wherein in particular the first display area (3) is arranged fully and the second display area (4a, 4b) only partially on the instrument cluster and/or wherein the second display area (4a, 4b) is arranged partially on the central display unit.

9. The method according to claim 8, wherein the second display area (4a, 4b) on the central display unit is demarcated from a third display area (5) by a second boundary line (7), wherein in particular an inclination of the second boundary line (7) is selected depending on the speed.

10. A user interface for displaying a traffic situation in a first display area (3) of a graphical user interface (1, 2) of a means of transportation (10), comprising:
a data input (11),
a data output (8), and
an evaluation unit (9), wherein the evaluation unit (9) is configured
to determine a speed of the means of transportation (10) by means of the data input (11) and
to adjust a vanishing point (x) of the representation of the traffic situation in the first display area (3) by means of the data output (8) depending on the speed.

11. The user interface according to claim 10, which is configured to carry out a method according to any one of the preceding claims 1 to 9.

12. A means of transportation comprising a user interface according to any one of the preceding claims 10 or 11.
